(19) United States
(12) Patent Application Publication
(10) Pub. No.: US 2015/0222709 A1
(43) Pub. Date: Aug. 6, 2015

(54) FACILITATING INTERACTIVE SUPPORT SESSIONS FOR AN EMBEDDED DEVICE USING A PORTABLE DEVICE

(71) Applicant: UpdateLogic, Inc., Plymouth, MN (US)

(72) Inventors: Kurt Roman Thielen, Maple Grove, MN (US); Christopher John Nigbur, Shakopee, MN (US)

(73) Assignee: UpdateLogic, Inc., Plymouth, MN (US)

(21) Appl. No.: 14/170,896

(22) Filed: Feb. 3, 2014

(51) Int. Cl. H04L 29/08

(52) U.S. Cl. CPC H04L 67/14; H04L 67/146

(57) ABSTRACT

An embedded device is connected to a portable device via an alternate connection that is separate from a first network interface used by the embedded device to connect to an Internet service. The Internet service provides support for the embedded device. The portable device connects to the Internet service via a second network interface of the portable device. First messages are exchanged between the portable device and the embedded device via the alternate connection, and second messages are exchanged between the portable device and the Internet service based on the first messages. The first messages and the second messages facilitate an interactive support session between the embedded device and the Internet service in place of the first network interface of the embedded device.

### BACKGROUND

The present disclosure relates in general to consumer electronic devices. Due to the ubiquity of inexpensive processors and other computing hardware, manufacturers are adding features that take advantage of such processors. For example, many televisions and set top boxes have the ability to stream movies from the Internet from a number of different content providers. While these additional features add value, they also add complexity. As such, configuring and servicing consumer electronic devices becomes more challenging.

### SUMMARY

The present disclosure is generally directed to facilitating interactive support sessions for an embedded device using a portable device. In one embodiment, a method and computer-readable medium facilitate connecting an embedded device to a portable device via an alternate connection that is separate from a first network interface used by the embedded device to connect to an Internet service. The Internet service provides support for the embedded device. The portable device connects to the Internet service via a second network interface of the portable device. First messages are exchanged between the portable device and the embedded device via the alternate connection, and second messages are exchanged between the portable device and the Internet service based on the first messages. The first messages and the second messages facilitate an interactive support session between the embedded device and the Internet service in place of the first network interface of the embedded device.

In another embodiment, a system includes an embedded device and a portable device. The embedded device includes a first processor, a remote user interface, and and a proximity connection means coupled to the remote user interface. The portable device includes a second processor coupled to a network interface. The portable device stores instructions executable by the second processor to exchange first messages with the remote user interface of the embedded device via the proximity connection means. The portable device also exchanges second messages with an Internet service based on the first messages. The first messages and the second messages facilitate an interactive support session between the embedded device and the Internet service.

The above summary not intended to describe each disclosed embodiment or every implementation detail thereof. For a better understanding of variations and advantages, reference should be made to the drawings which form a further part hereof, and to accompanying descriptive matter, which illustrate and describe representative embodiments.

### BRIEF DESCRIPTION OF THE DRAWINGS

In the following diagrams, the same reference numbers may be used to identify similar/same components in multiple figures. Figures are not necessarily to scale.

FIG. 1 is a block diagram illustrating a system according to an example embodiment;

FIG. 2 is a block diagram illustrating functional components of embedded and portable devices according to an example embodiment;

FIG. 3 is a block diagram illustrating functional components of embedded and mobile devices according to another example embodiment;

FIGS. 4 and 5 are block diagrams illustrating an interactive support session according to an example embodiment; and

FIGS. 6-8 are flowcharts illustrating methods according to example embodiments.

### DETAILED DESCRIPTION

In the following description of various example embodiments, reference is made to the accompanying drawings that form a part hereof, and in which is shown by way of illustration various example embodiments. It is to be understood that other embodiments may be utilized, as structural and operational changes may be made without departing from the scope of the present invention.

The present disclosure is related to systems and methods that assist in remote servicing of embedded devices. Generally, embedded devices include computing devices with special-purpose processors and associated circuits that perform a limited set of well-defined tasks. Embedded devices may have some facilities for extending their functionality, but may be generally difficult for users to apply, e.g., requiring a firmware update. This is in contrast to a general-purpose computer, that may have no specific function as built (other than utilities that facilitate running of an operating system), and is designed from the outset to be easily user-configurable to extend functionality through the addition of programs to memory. Embedded devices may include appliances, consumer electronic (CE) devices, automotive devices/components, automation controller (e.g., heating and air conditioning), robots, etc.

Over the last few decades, embedded devices have become not only more pervasive, but increasingly sophisticated. For example, even special-purpose devices such as televisions and appliances may have embedded processors with as much processing power as personal computers from decades past. These devices may also have other interfaces (such as user and network interfaces) that allow the devices to perform functions commonly associated with personal computers.

While the capabilities of modern embedded devices may parallel those of personal computers, consumer expectations of how such devices should operate is markedly different from that of personal computers. For example, while users may be tolerant of the complexity that provides the ability (or need) to highly customize a personal computer, more often than not, they expect an embedded device to work right out of the box without any further work beyond the initial setup.

The consumer expectation of out-of-the-box reliability is increasingly at odds with the increasing amount of features included in embedded devices. For example, a modern television may need to process multiple analog and digital video and audio formats from numerous different interfaces (e.g., antenna, analog and digital cable inputs), as well as process data from one or more computer-type interfaces, such as Universal Serial Bus (USB) data ports, Ethernet ports, and wireless networking chipsets. These can be used to access and display different types of media, such as photo albums stored on a USB thumb drive or Internet streaming video.

The increasing complexity of modern embedded devices leads to an increased chance of failure of some aspect of the device. These failures may be due to hardware, in which case a physical repair may be needed. The failures may also be due to a software error or configuration error that can be solved by an update and/or reconfiguration. While a modern device may have facilities that allow consumers to diagnose failures, it is rarely the case that consumers are able to do this. One reason is that it is expensive to design user-friendly interfaces that facilitate diagnoses of device problems. Even if the device has user-accessible diagnostics, such devices may have user-interface devices with limited capabilities (e.g., infrared remote control), and so it may be difficult to maneuver around such an interface. Also, unlike a computer operating system, there is no standardized way between different devices manufacturers to look at system status, apply updates, etc. So even for a technically capable end-user, the learning curve for servicing a device may be steep, in the event such capability is provided at all.

In recognition of this, newer embedded devices may include remote management features that facilitate remote support of an embedded device. Generally, the embedded device includes a support module with Internet access capabilities. The support module includes the capability to both read configurations from and apply changes to the embedded device. The support module further has the capability to connect via the Internet to a support service, where a support technician can remotely access, with the user's permission, the embedded device. This can avoid costly repair visits, product returns, etc., due to software and configuration problems.

Generally, when a user first sets up a network-capable device in their home, they may try to connect the device to a home network, assuming that such a network exists. Due to the wide adoption of broadband Internet access and Network Address Translation (NAT) routers, it may be assumed for a large number of users that a home network exists. If so, the user may also be aware of how to access the network, whether by plugging in an Ethernet cable or using a password to access a wireless network access point. Thereafter, if the user experiences problems, they may have the option to connect the malfunctioning device to the support service via the support module and communicate with a technician associated with the support service to diagnose the problem.

The support module and other system components described herein allow Original Equipment Manufacturers (OEMs), retailers, silicon vendors, streaming service providers, and call centers to manage Digital Rights Management (DRM) security, update firmware, and remotely access any type of Internet-connected consumer electronics product. Such a support module may also facilitate automatic operations to be performed on the embedded device, if the user chooses to enable them. One example of this is automatic firmware updates, which can be used to resolve problems that have been found after the product was sold. Other data, such as program guides, addresses of network services, etc., can be automatically pushed to devices via this mechanism.

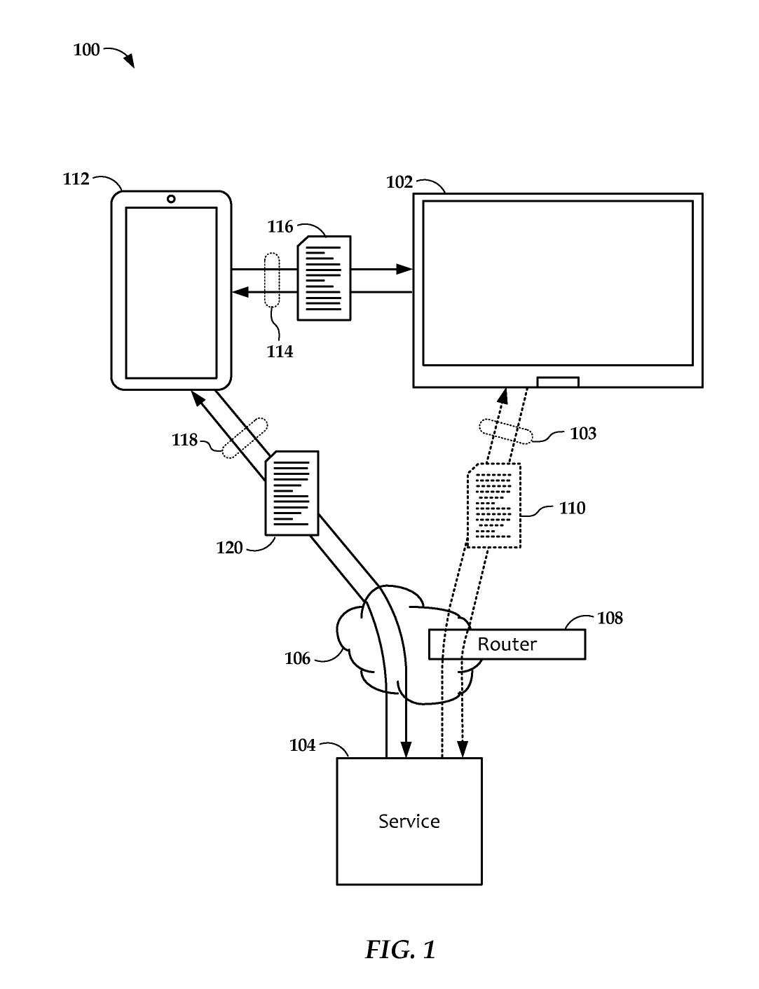

While the use of an Internet-connected support module has been found to be quite useful, one issue that sometimes arises is where the embedded device's support module is unable to connect to the Internet via a home network. This may result from a number of issues, such as a misconfigured or failed router, loss of Internet connectivity, and inability of the end-user to understand how to connect to the network. In some cases, the support module may be unable to connect to the home network because such functionality is not included in the device. As such, this prevents the support module from being used for its intended purpose. In FIG. 1, a block diagram shows a system 100 that addresses this issue according to an example embodiment.

Generally, the system 100 includes an embedded device 102, here shown as a television. The embedded device 102 includes a support module (not shown) that facilitates a connection 103 to a support service 104 that is accessible via the Internet 106 through a home router 108. Data, represented by message 110, is exchanged with the service 104 to facilitate monitor and/or control of the embedded device 102. However, as indicated by the dashed lines, the connection 103 cannot be established, possibly due to the router 108 or embedded device 102 being misconfigured or malfunctioning. In other cases, the embedded device 102 may not have hardware installed that facilitates Internet connectivity.

In order to at least initially establish communications between the service 104 and the embedded device 102, a network-capable portable device 112 is utilized (also referred to as mobile device). The portable device 112 may include a smartphone, tablet, etc., and generally has access to the Internet 106. This Internet access may be provided by the router 108 (e.g., via wireless networking, generally referred to as Wi-Fi™) or via cellular data networks. The latter is useful, as it can provide a means of communication even in the event of a failure of the router 108.

In some scenarios, the portable device 112 may be configured as a generic Internet gateway, e.g., a Wi-Fi hotspot, that acts as a wireless infrastructure access point that routes Internet traffic over the cellular data connection. In such a case, the portable device 112 acts as a replacement for the router 108. However, if the inability to connect to the service 104 is due to a failure or misconfiguration within the embedded device 102, then this alternate network connection means may not be effective. In addition, while the portable device 112 may be capable of acting as a generic Wi-Fi hotspot, such functionality may be blocked by the cellular service provider. As such, the portable device 112 will include software that facilitates an alternate connection path 114 between the embedded device 102 and the portable device 112. While this alternate path 114 may include networking capabilities, it is generally different than infrastructure Internet Protocol (IP) networking that would be provided by the router 108 or a Wi-Fi hotspot.

The alternate connection 114 may include proximity networking (also referred to as personal area networking or local-link networking) such as Bluetooth™, ZigBee™, and ad-hoc Wi-Fi. The alternate connection 114 may use other wireless protocols, e.g., home automation protocol such as Z-Wave™. Other wireless data transfer means that may be used by the alternate connection include infrared specifications as defined by the Infrared Data Association (IrDA™) and Near-Field Communications (NFC). The alternate connection 114 may also or instead use a wired connection, including Mobile High-Definition Link (MHL™), Universal Serial Bus (USB™), etc. Generally, any data connection means that facilitates two way data communications between the portable device 112 and embedded device 102 may be used as an alternate connection 114, with availability and convenience among the considerations for selection.

Using the alternate connection, first messages 116 are exchanged between the portable device 112 and the embedded device 102. These first messages 116 may be that same as or similar to the messages 110 that the embedded device would otherwise exchange directly with the service 104. For example, the first messages 116 may include the same payload data but different headers than messages 110. The portable device 112 has an application that performs, among other things, maintaining the alternate connection 114 and processing the first messages 116, and processing second messages 120 that are based on the first messages 116.

The application on the portable device 112 may allow it to act as a proxy for the embedded device 102. As such, the service 104 does not need to have any knowledge that the portable device 112 is being used, which simplifies implementation of the service 104. The portable device 112 at least connects to the service 104 via the Internet, as indicated by Internet connection 118. The portable device exchanges second messages 120 with the service 104 that may include at least a payload of first messages 116 that originate from the embedded device 102. Similarly, the portable device 112 may exchange first messages 116 with the embedded devices that include a payload of second messages 120 that originate from the service 104. It will be understood that descriptions herein of processing of the second messages 120 based on the first messages 116, or vice versa, may involve processing messages in either direction.

The portable device 112 may operate as a pass-thru, converting between the protocol data used by the different connections 114, 118, but otherwise does not need to be aware of the content of the messages. In other embodiments described below, the portable device 112 may include features that involve direct interaction with the service 104 that may not need to involve exchanging messages with the embedded device 102. For example, the portable device 112 may be used to access session codes that provide access to the embedded device 102, and facilitate sending those codes to the service 104. Similarly, the portable device 112 may include features that involve direct interaction with the embedded device 102 that may not need to involve exchanging messages with the service 104. For example, the portable device 112 may be involved in service discovery and connection setup of the alternate connection 114 with the embedded device 102.

The messages 116, 120 facilitate interactive support sessions between the embedded device 102 and the service 104. The messages 116, 120 may allow an agent of the service 104, either human or automated, to view and change settings of the embedded device 102, view snapshots of media being processed by the embedded device 102, and remotely control a user interface of the embedded device 102. These functions may be interrelated. For example, settings can be viewed and changed by presenting a remote view of the embedded device's user interface to the service 104. Whatever is performed in the remote view may also be mirrored at the embedded device 102 and/or the portable device 112. In such a configuration, an operator/agent at the service 104 can also use remote control of the user interface for other purposes, such as instructing an end user on how to use the embedded device 102. The support module of the embedded device 102 may allow the agent to highlight portions of a display, move a cursor, etc., to facilitate this type of instruction.

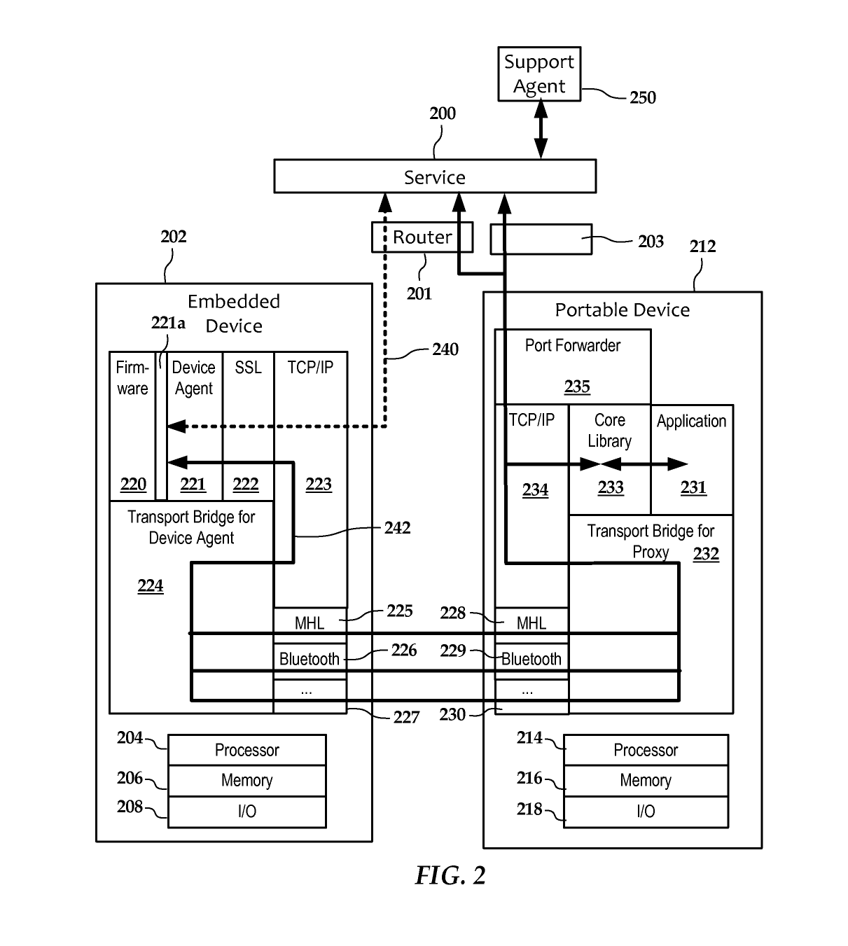

In FIG. 2, a block diagram illustrates details of an embedded device 202 and portable device 212 that interact with Internet service 200 (via home router 201 or other network component 203, such as a mobile gateway) to provide interactive support according to an example embodiment. Generally, the devices 202, 212 include one or more processors 204, 214. The processors 204, 214 may include any combination of Application Specific Integrated Circuits (ASICs), System on a Chip (SoC), general-purpose Central Processing Units (CPUs), and other general-purpose or specialized logic circuitry.

The memory 206, 216 may include volatile and non-volatile memory, and may store instructions usable by the processors 204, 214 to perform the functions described herein. The memory 206, 216 may also store data, such as configurations, settings, measurements, etc. The processors 204, 214 and memory 206, 216 are coupled to input/output hardware 208, 218 which may include, among other things, user interface hardware, media rendering hardware, and external data transfer interfaces.

The processors 204, 214 and memory 206, 216 may be configured with instructions associated with the illustrated functional component blocks 220-235. The embedded device 202 includes firmware 220 that controls device-specific functions such as hardware control, media encoding/decoding, user interface controls, power management, etc. The firmware 220 is generally provided by a manufacturer of the embedded device 202. The manufacturer incorporates software components 221-227 that interfaces with the firmware 220. Some of the components 221-227 may be provided from a third-party, e.g., a provider associated with service 200.

A device agent 221 is an interface between the firmware 220 and the other software components 222-227. The device agent 221 may utilize an application program interface (API) 221a that allows device manufacturers to adapt the firmware 220 to interact in a generic way with the device agent 221. The API 221a may include functions that allow remote control of the firmware 220, provide network hardware access to the software components 221-227, expose internal data and/or media, receive and apply software or firmware updates, manage security, etc. Generally, the device agent API 221a allows interactive support functionality to be implemented in a wide variety of embedded devices without having to write a custom device agent 221 for every device.

The device agent 221 connects to the service 200 via a Secure Sockets Layer (SSL) component 222 and Transmission Control Protocol/Internet Protocol (TCP/IP) stack 223. This is a default connection, and is indicated by path 240. However, as noted above, if there is a network misconfiguration or failure within the embedded device 202 or elsewhere within the home network, then the path 240 will be unavailable. The embedded device 202 may also be provided without network hardware, in which case it determines (e.g., via configuration settings) that default path 240 is not available. As such the device agent 221 can utilize an alternate path 242 which uses the portable device 212.

The portable device 212 may be user-modified to include an application 231 that facilitates network operations on behalf of the embedded device 202. In this example, a core library 233 provides the primary functions of the application 231 described herein. The application 231 wraps the functions of the core library 233, which may be included together as part of a single installable package. This allows customization of the user interface and custom branding of the application 231. For purposes of the following discussion, the core library 233 may be considered part of the application 231.

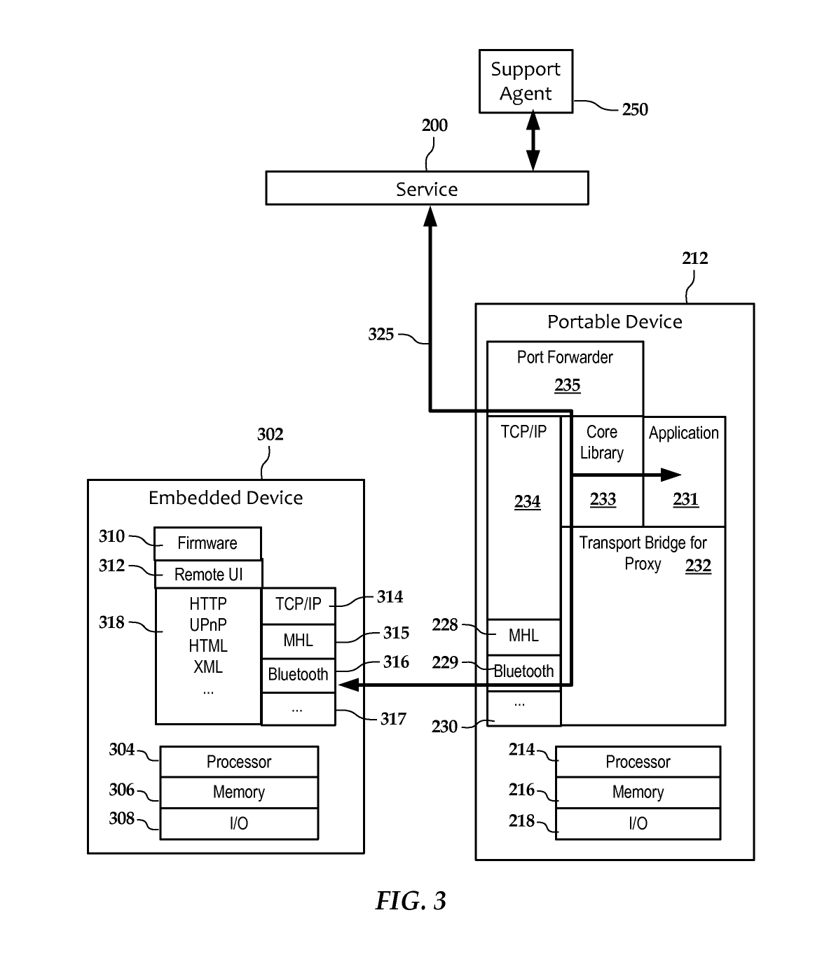

The network operations performed by application 231 may include, among other things, routing services, proxy services and support services. The routing and proxy services are described here in relation to FIG. 2. The support services are described below in relation to FIG. 3. Many of these operations may be provided by the core library 233, such as maintaining state information for each embedded device connecting to the service 200. For proxy-type services, this involves maintaining information regarding a services endpoint and the registration state of the embedded device 202 in order to correctly construct the endpoint used for the services.

The application 231 may be configured to provide the aforementioned routing services using the portable device's built-in Wi-Fi infrastructure or hotspot capabilities. The application 231 may cause the portable device 212 to present to the embedded device 202a well-known wireless network with which the embedded device 202 can connect to automatically, e.g., with little or no user input. This is analogous to tethering, except that the application 231 can limit connection to devices having the appropriate device agent 221, and may place other limitations on the network connection (e.g., bandwidth, port numbers, destination IP address, wireless network identifier) so that data carriers will not consider the connection as general-purpose tethering.

Another operation provided by the application 231 may include proxy services using any of the alternate communication modules 225-230. Data exchanged with the embedded device 202 is passed through the portable device 212 to the service 200 via the above-mentioned alternate path 234. For purposes of convenience, the alternate path 242 may use the same SSL component 222 and TCP/IP stack 223 used in the primary path 240. For example, a transport bridge component 224 may set up a TCP/IP socket that listens on a loopback address. The device agent 221 connects to the loopback address and utilizes and communicates the data via transport bridge 224. Other interprocess communications (IPC) may be used instead of TCP/IP to communicate between the device agent 221 and transport bridge 224, such as operating system messaging, shared memory, pipes, etc.

The transport bridge 224 is configured to pass data from the device agent 221 using an alternate protocol and/or medium, as indicated by connection modules 225-227 in the embedded device, and associated connection modules 228-230 in the portable device 212. The connection modules 225-230 can be generically utilized by the transport bridge 224, e.g., each module 225-227 may have a generic interface used by the transport bridge 224. This allows extending the functionality of the transport bridge 224 to use any alternate communication means available to both the embedded device 202 and the portable device 212.

Modules 225, 228 connect via MHL, which may be utilized by connecting a High-Definition Multimedia Interface (HDMI™) cable between the devices 202, 212. Modules 226, 229 utilize Bluetooth, which may be initiated via a wireless device discovery and pairing operation. Other protocols and/or media may be used, as indicated by modules 227, 230. These protocols/media may include any described herein, including ad-hoc Wi-Fi, Z-Wave, Zigbee, NFC, IrDA, Universal Plug-and-Play (UPnP™), Digital Living Network Alliance (DLNA™), Zeroconf, AllJoyn™, Open Garden, etc.

The portable device 212 may already include the connection modules 228-230 as part of the operating system and device drivers. The application 231 uses a transport bridge 232 to connect from connection modules 228-230 to an associated one of the connection modules 225-227 of the embedded device 202. Messages are relayed between the transport bridge 232 and a TCP/IP stack 234 and proxy/port forwarder 235, which connect to the service 200 via the Internet.

The port forwarder 235 contains the facilities to redirect inbound connections from the embedded device 202 through the portable device 212 to the service 200. The proxy/port forwarder 235 may be configured to support inbound connections on the portable device's network interfaces (e.g., Wi-Fi or cellular data), the loopback interface and the Bluetooth interface. The proxy/port forwarder 235 supports outbound connections on the device's network interfaces. The port forwarder 235 itself may not need to maintain secure connections. The embedded device 202 (e.g., via SSL module 222) and the service 200 may be configured to handle the necessary SSL capabilities.

The application 231 has a user interface that assists the user in establishing connectivity between the embedded device 202 and the service 200. The application 231 provides information to the user regarding the state of the different connection modules 225-230 along with the ability to configure the different connection modules 225-230. Where necessary, the application 231 may also present the user with disclaimers regarding certain local-link technologies. For example, some Wi-Fi modes may require authorization from the carrier before being enabled.

When the portable device 212 is providing routing or proxying services to embedded device 202, the application 231 displays status appropriate for mode of connectivity being used. The application 231 may also allow the enable and disable functionality for that mode of connectivity. Additionally, the application 231 may also display information and status appropriate for devices engaging in support activities. For example, the application 231 may display a session code, the session having been started on behalf of the embedded device 202. The application 231 may also display the status of the session and allow the user to terminate the session.

The devices 202, 212 may be configured to interact in a number of ways. In one scenario, the user may unsuccessfully attempt to connect the embedded device 202 to a local network. In response, the user may be informed of the existence of the interactive support service 200. For an embedded device such as a TV, a help screen can be displayed that includes any combination of a phone number, network address, machine-readable code, etc., that allows the user to either contact a service representative or directly download software (e.g., the application 231 and other components such as core library 233 and transport bridge 232) to their own portable device 212. For example, the TV could display a QR-code that links to a software store used by the portable device 212. The software store facilitates download and installation of the software to the portable device 212. If the embedded device 202 does not have a display, similar indicia may be provided by a service manual, stickers/tags affixed to the device, audio prompts from the device, etc.

Once downloaded and running, the application 231 may prompt the user to connect to the embedded device 202 via Bluetooth, MHL, etc. Once connected, the application 231 may query the embedded device 202 for data, such as device type, model number, etc. In another configuration, the application 231 and associated components may just set up a TCP/IP connection (e.g., tunnel) to the service 200, and allow the device agent 221 to send any needed data. In such a case, the application 231 (e.g., via core library 233) behaves as a data forwarder, and need not have or require any knowledge of the underlying data being transferred to the service 200 from the embedded device 202.

In an alternate scenario, the user may have previously downloaded software that may or may not be specific to the embedded device 202, and this software may be used to discover the embedded device via proximity networking. For example, a general-purpose application (e.g., corresponding to a logo or trade name shown on the embedded device 202) may be configured to scan for supported devices. Once discovered, the general-purpose application may already be able to connect to the embedded device 202, or do so after the installation of additional modules. In such a case, the general-purpose application may operate similar to application 231 described above.

In some cases, the application 231 may also communicate independently from the embedded device 102. For example, once the device agent 221 has established a network connection to the service 200, the service 200 may generate a session code or other security token that allows an agent 250, either human or automated, remotely located with the service 200 to connect to the embedded device 202. The session code may be communicated by a user interface of the application 231, voice, text, secondary channels, etc. The session code prevents other remote agents of the service 200 from viewing or controlling device agents without express authorization of an end user. In such a case, the application 231 may prevent access to the embedded device 102 without this session code, freeing the embedded device 102 from having to perform this check. It will be understood that in other embodiments, other entities may generate a session code for similar uses, such as the embedded device 202, portable device 212, and third party service (not shown).

In order to authorize a remote support agent 250 to use the device agent 221, the end user may communicate the session code to the support agent 250, e.g., via a telephone call. However, such a call may not be possible or needed using the application 231. For example, the portable device 212 may be the only telephone the user has, and some cellular phones do not permit simultaneous data sessions and voice calls. In such a case, the application 231 may include a communication means such as Internet chat, simple message service (SMS), voice over IP (VoIP), etc., that can be used to communicate with the support agent 250. In such a case, the user may still receive the session code from the embedded device 202, but may communicate the session code to the remote agent 250 by keying it into the portable device 212. In other cases, the portable device 212 may automatically relay the session code via a secondary channel after receiving authorization from the user via the application 231.

The session code 212 provides authentication/security between the service 200 and local devices 202, 212. The local devices 202, 212 may also have mechanisms for authentication/security between each other, such as those built into Wi-Fi and/or Bluetooth. These authentication/security mechanisms may involve use of passcodes. In some cases, the embedded device 202 may not have a user interface suitable for displaying a passcode to the user. In such a case, a fixed passcode may be already displayed on the device may be used, such as part of a serial number or a number embedded in a machine-readable code. In the alternate, the application 231 may be configured to query the embedded device 202 for a passcode, e.g., via near-field communications. In such a case, the passcode may be randomly generated by the embedded device 202 for added security.

Generally, the embedded device 202 and portable device 212 may rely on their proximity to ensure unauthorized users cannot connect to either device using the remote support interfaces. For example, embedded devices with display elements such as televisions may be able to generate and display a local session passcode that can be entered into the portable device 212 to connect to the embedded device 202. Other means of communicating a proximity-limited passcode may be used, such as static or dynamic bar codes, computer-generated voice output, flashing of LEDs, infrared transmitter, near-field communications, etc. In other cases, the user (e.g., via instruction from the application 231) may be able to press one or more keys/buttons on the embedded device 202 that facilities open connections via proximity networking for a short amount of time. Thereafter, the embedded device 202 and portable device 212 may save data that allows future communications without such pairing, or may delete such data after termination of the support session.

After connecting the embedded device 202 with the portable device 212, the user and/or support agent 250 may be able to diagnose network problems with the embedded device 202. In cases where the inability to connect to the service 200 is due to a misconfiguration within the embedded device 202, the remote agent may be able to quickly resolve the problem remotely. If so, the embedded device 202 can then connect through path 240 to verify, either in parallel with the existing connection path 242 or after disconnecting from path 242. If the inability to connect to the service 200 is due to a fault in the home network, then the application 231 may be configured with additional functions to assist in resolving the fault.

If the portable device 212 has previously connected to the home network, e.g., through a Wi-Fi router 201, the portable device 212, either through user input or through the assistance of the remote agent 250, may be able to send its Wi-Fi credentials to the device agent 221 of the embedded device 202. Oftentimes, users may forget the passwords used to connect to network, or may mis-type the passwords due to limited user input facilities (e.g., on screen keyboards, remote controls) available on the embedded device 202.

If the portable device 212 is providing the Internet part of the connection 242 via a cellular phone network, it may also send its Wi-Fi media access control (MAC) address to the device agent 221 for temporary testing. If the router 201 is using MAC filtering, the embedded device 202 may not be able to connect even if it has the proper credentials. Many network interfaces allow the changing of the MAC address in software (often called “spoofing”), and so if the MAC address of the portable device 212 has previously been allowed, spoofing its address in the embedded device 202 will reveal MAC filtering issues. If the portable device 202 is currently providing the Internet part of the connection 242 via Wi-Fi, it may need to disconnect from Wi-Fi in order to allow this type of test to proceed.

In order to deal with a failed or misconfigured router 201, the actions available to the service 200 to resolve the problem may be limited depending on the make and model of the router 201. Assuming the end user can physically access the router 201 and the portable device 212 includes a camera, the application 231 may be configured to at least take and send a photograph of a device information sticker on the router 201, which may include such information as make, version, and serial number. This may allow the agent 250 to recommend options, such as activating Wi-Fi protected setup (WPS) if so available, resetting the router to factory settings, access using factory default administrator credentials, etc. Some of these may be performed remotely. For example, if the portable device 212 is connected to the router 201 via Wi-Fi, the agent 250 (with user consent) may be able to initiate a browser session with the router 201 via the application 231, e.g., acting as a proxy. The agent 250 may then attempt to login to the router 201 via a Web-based administrative interface in an attempt to resolve the problem.

It will be understood that the home router 201 may contain similar functionality as the illustrated embedded device 202. In such a case, if the user is having difficulty connecting another embedded device, the procedures described above can be used to connect to the router 201 via a portable device 212 using the router's own device agent 221. Even if the user is not having difficulty connecting via the router 201, use of the portable device application 231 and device agent 221 may be preferred by users in performing router setup as opposed to other ways, such as via a web browser.

While the scenarios described in FIG. 2 relate to an inability of the embedded device 202 to connect to the support service 200, it will be understood that the application 231 and associated modules may provide functionality usable even when the embedded device can connect to the service. For example, as described above, it may be easier to communicate data such as session codes via the portable device 212. In other cases, the portable device 212 may be already used together with the embedded device 202, e.g., as a wireless remote control, and so extension of the support service to the portable device 212 may be natural from the user's perspective.

As described above, another function that may be provided by the application 231 is support services. In such a scenario, the portable device 212 provides support services to embedded devices that do not have a device agent that is compatible with the service 200. In such a case, the portable device 212 may act as a support device (e.g., proxy for device agent 221) on behalf of the embedded device 202. The devices may use local-link technologies such as Simple Network Management Protocol (SNMP), UPnP and others to interact with each other. The support capabilities in this type of configuration may be limited to the interaction available through the available local-link technologies. This type of support service may be implemented by adding functionality in the application 231 and core library 233.

In FIG. 3, a block diagram illustrates an example of supporting a device, indicated here as embedded device 302 using portable device 212. The embedded device 302 does not have a device agent 221 as shown in FIG. 2 that was expressly designed to be compatible with the application 231 and associated functions. The embedded device 302 may have other capabilities that allow some level of support to be provided from the portable device 212 and/or service 200.

Similar to embedded device 202 in FIG. 2, embedded device 302 may include processor 304, memory 306, and I/O 308. The embedded device 302 may also have firmware 310 for performing general functions, and such functions may be remotely accessible via a remote user interface 312. The remote user interface 312 allows remote data connections via connection modules 314-317, which may be similar to those described in FIG. 2. An intermediary protocol layer 318 may use standards such as SNMP, HTTP, UPnP, HTML, XML, Telnet, Secure Shell (SSH), etc., to present user interface data and manage sessions between one or more of the connection modules 314-317 and the remote user interface 312. As a result, the core library 233 and application 231 may be extended to allow access to device 302 for use by the service 200, as indicated by path 325. The application 231 and core library 233 may use session codes and the like as described in relation to FIG. 2 to secure remote sessions with the service 200.

The portable device 212 may act as a port forwarder for other types of traffic, including local IP traffic. For example, if the remote user interface 312 is accessible via an HTTP connection, the portable device 212 may find the IP address of the embedded device 302 using known discovery mechanisms, and pass the address to the service 200. Thereafter, the service 200 may initiate an HTTP connection to the embedded device 302 via the portable device 212, which forwards all connection requests and data packets between the two. The service 200 can then log in to the embedded device 302 using this connection and perform support operations.

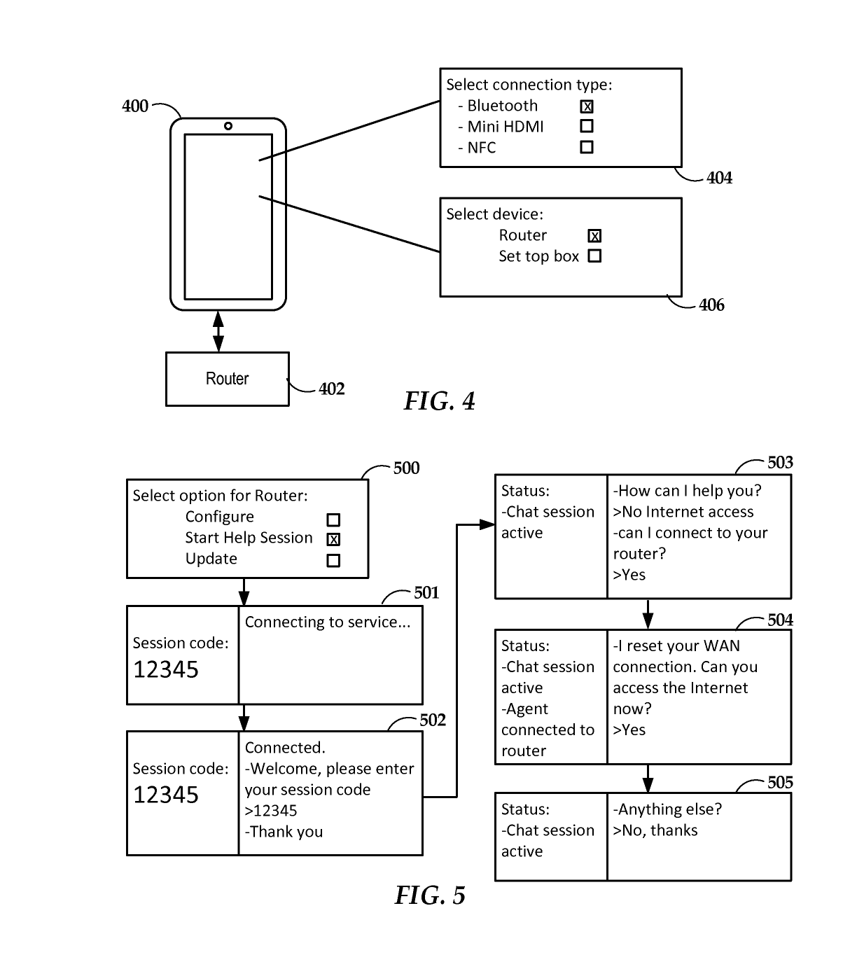

In reference now to FIG. 4, a block diagram illustrates how a portable device (e.g., smartphone 400) may be used to facilitate remote service for an embedded device (e.g., router 402). This display may be presented by remote service application (e.g., application 231 in FIG. 2) installed on a portable device. As seen in example display screen 404 of the smartphone 400, the user may select which communication means may be queried to search for available devices. More than two communication means may be selected, and the querying may be done automatically on all available interfaces. In display screen 406, two devices have been found, and the router 402 has been selected by the user.

In FIG. 5, additional display screens of smartphone 400 are illustrated. After the router 402 has been selected, a list of tasks is shown in screen 500. The user may be able to configure the router 402 from the smartphone 400 and/or apply a firmware update. In this example the user has selected to start a remote help session, which leads to display screen 501. Screen 501 (and subsequent screens 502-505) is a split-screen view, with status messages on the left and interactive messages (e.g., text or chat messages) on the right. It will be understood that if alternate person-to-person communications, e.g., voice, are used, the right split screen may not be needed.

Screen 501 is indicating that the smartphone 400 is connecting to the service, and has generated a session code seen in the left screen. This code may be generated by either the router 402 or the smartphone 400. In screen 502, a connection with a remote agent of the service has been established. The user has been invited to provide the session code, which is entered in the right hand screen. In screens 503-505, the support session proceeds, with the remote agent gathering more information at screen 503, connecting to the router and resetting a network interface at screen 504, and concluding at screen 505. The screens may include other user interface elements not shown, such as controls to disconnect the session at any time, a user interface screen that mirrors what the remote agent is currently doing, etc.

It should be noted that in some embodiments, the data sent by the embedded device is encrypted by the embedded device, e.g., using SSL or some other secure transmission protocol. The portable device may pass the data along to the network service without decrypting the data, leaving it to the network service to decrypt the data to use in the session. As such, the session data shown in FIG. 5 (e.g., chat session active, agent connected to router) may be sent via a secondary channel. As previously noted, the support application used by the portable device may facilitate person-to-person communications (e.g., voice, text) and so the supplemental data may be sent by these alternate channels. The alternate channels may be secured or unsecured.

Generally, supplemental data sent by an alternate channel may include any data that updates a user of interactive support session status. Supplemental data may include person-to-person communications, connection status data, device status data, device media samples, etc. This includes session codes that are generated by the portable device or embedded device. In the case where the supplemental data includes embedded device data sent by the secure, primary channel (e.g., SSL data sent via transport bridges), the service may sanitize or otherwise process the supplemental data if the alternate channel is not secure. Also, the application may need to take precautions to ensure that the supplemental channel is not available to directly control or connect to the embedded device. This may involve securing the channel or limiting the internal uses of the secondary channel within the application.

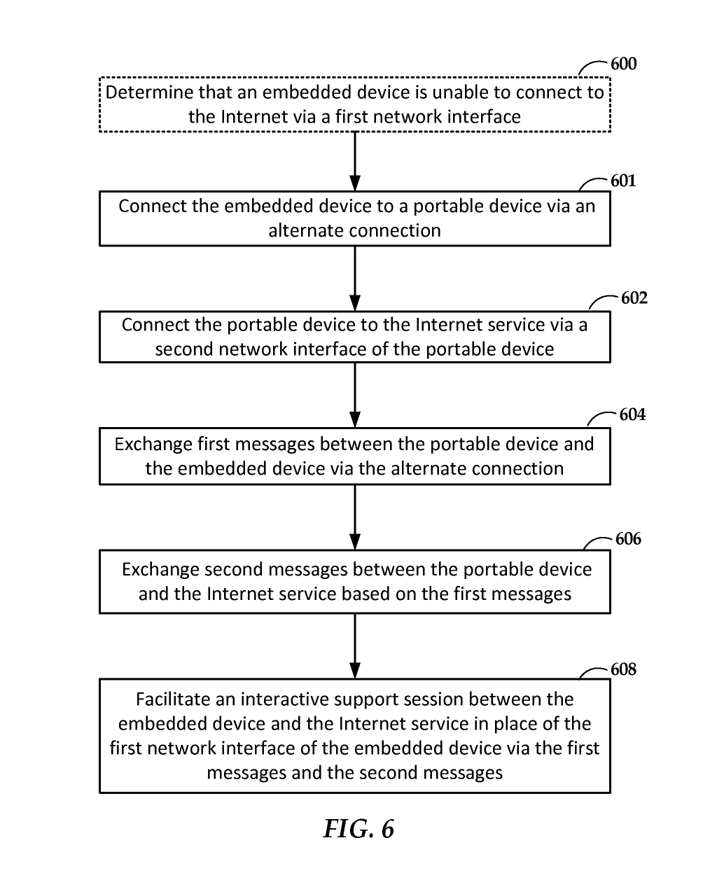

In reference now to FIG. 6, a flowchart illustrates a method according to an example embodiment. As indicated in block 600, the method may be performed in response to determining that an embedded device is unable to connect to the Internet via a first network interface. It will be understood the method may be performed for other reasons, e.g., slow Internet service on the home network.

The method involves connecting 601 the embedded device to a portable device via an alternate connection. The alternate connection is separate from a first network interface used by the embedded device to connect to an Internet service that provides support for the embedded device. It will be understood that “separate” network interfaces may share some common hardware or protocols, but not all. For example, ad-hoc Wi-Fi and infrastructure Wi-Fi may share the same radio hardware and some protocol stacks (e.g., TCP/IP), but other protocols, such as routing and authentication, are different. The portable device connects 602 to the Internet service via a second network interface of the portable device. Generally, this second network interface is separate from a network interface of the portable device used to connect to the embedded device.

First messages are exchanged 604 between the portable device and the embedded device via the alternate connection, e.g., via wireless proximity networking or a wired multimedia interface. Second messages are exchanged 606 between the portable device and the Internet service based on the first messages. The first messages and the second messages facilitate 608 an interactive support session between the embedded device and the Internet service in place of the first network interface of the embedded device. This may involve, for example, the portable device acting as an Internet proxy for the embedded device. The first messages and second messages may be encrypted, in which case the portable device may exchange the first and second messages without decrypting payloads of the first and second messages.

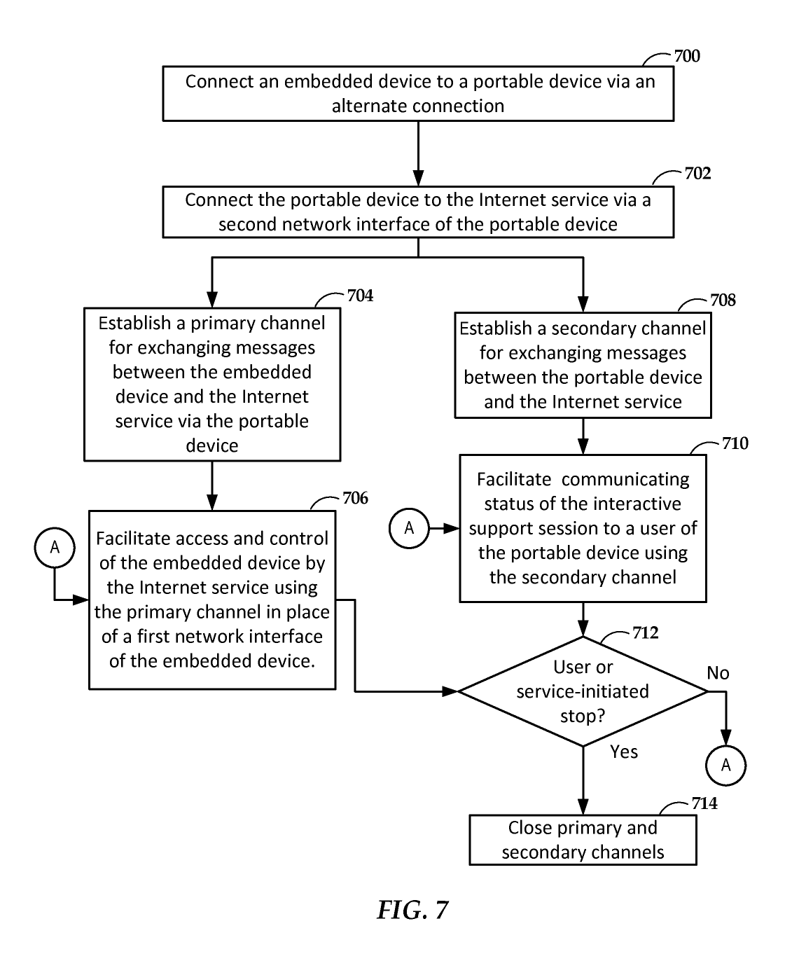

In reference now to FIG. 7, a flowchart illustrates a method according to another example embodiment. The method involves connecting 700 an embedded device to a portable device via an alternate connection. The alternate connection is separate from a first network interface used by the embedded device to connect to an Internet service that provides support for the embedded device. The portable device connects 702 to the Internet service via a second network interface of the portable device.

After connection to the Internet service, primary and secondary channels are established 704, 708. The terms “primary” and “secondary” are used for convenience for distinguishing between the channels, and are not intended to indicate relative importance, bandwidth, priority, quality-of-service, etc., although it may be desirable in some cases to set different parameters for the channels. The primary channel is used to exchange messages between the embedded device and the portable device. This facilitates 706 access and control of the embedded device by the Internet service using the primary channel in place of a first network of the embedded device.

The secondary channel is used to exchange messages between the portable device and the Internet service. This facilitates 710 communicating status of the interactive support session (e.g., access and control operations occurring on the primary channel) to a user of the portable device. Either the user or the service may initiate a stop, is indicated by block 712. In such an event, the primary and secondary channels are closed 714. The channels may be opened or closed independently. For example, the user may wish to halt access to the device by closing the primary channel, but keep the secondary channel open for further person-to-person communications.

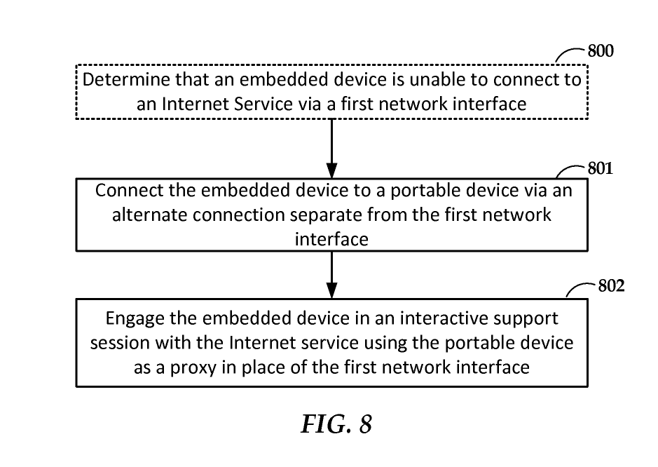

In reference now to FIG. 8, a flowchart illustrates a method according to another example embodiment. As indicated in block 800, the method may be performed in response to determining that an embedded device is unable to connect to an Internet service via a first network interface. It will be understood the method may be performed for other reasons, e.g., determining there is slow Internet service on the home network, determining that the embedded device does not have network capability. The method involves connecting 801 the embedded device to a portable device via an alternate connection. The alternate connection is separate from a first network interface used by the embedded device to connect to the Internet service. The embedded device engages 802 in an interactive support session with the Internet service using the portable device as a proxy in place of the first network interface.

The various embodiments described above may be implemented using circuitry and/or software modules that interact to provide particular results. One of skill in the computing arts can readily implement such described functionality, either at a modular level or as a whole, using knowledge generally known in the art. For example, the flowcharts and component diagrams illustrated herein may be used to create computer-readable instructions/code for execution by a processor. Such instructions may be stored on a non-transitory computer-readable medium and transferred to the processor for execution as is known in the art. The structures and procedures shown above are only a representative example of embodiments that can be used to perform functions as described above.

The foregoing description of the example embodiments has been presented for the purposes of illustration and description. It is not intended to be exhaustive or to limit the inventive concepts to the precise form disclosed. Many modifications and variations are possible in light of the above teaching. It is intended that the scope of the invention be limited not with this detailed description, but rather determined by the claims appended hereto.

What is claimed is:

1. A method, comprising:
connecting an embedded device to a portable device via an alternate connection that is separate from a first network interface used by the embedded device to connect to an Internet service that provides support for the embedded device;
connecting the portable device to the Internet service via a second network interface of the portable device;
exchanging first messages between the portable device and the embedded device via the alternate connection; and
exchanging second messages between the portable device and the Internet service based on the first messages, the first messages and the second messages facilitating an interactive support session between the embedded device and the Internet service in place of the first network interface of the embedded device.

2. The method of claim 1, wherein the portable device is configured to act as an Internet proxy for the embedded device.

3. The method of claim 1, wherein the first messages are exchanged via wireless proximity networking.

4. The method of claim 1, wherein the first messages are exchanged via a wired multimedia interface.

5. The method of claim 1, further comprising determining that the embedded device is unable to connect to the Internet service via the first network interface, and performing the method of claim 1 in response thereto.

6. The method of claim 1, wherein the first messages and the second messages are encrypted, and wherein the portable device exchanges the first and second messages without decrypting payloads of the first and second messages.

7. The method of claim 1, further comprising establishing a secondary data channel between the portable device and the Internet service, the secondary data channel being active during the interactive support session and facilitating communicating status of the interactive support session to a user of the portable device.

8. The method of claim 7, further comprising:
generating, by one of the embedded device or the portable device, a session code that permits access to the embedded device via the Internet service;
displaying the session code to the user; and
facilitating user communication of the session code to the Internet service via the secondary data channel.

9. A non-transitory, computer-readable medium configured with instructions operable by a processor of a portable device to cause the portable device to:
connect to an embedded device via an alternate connection that is separate from a first network interface of the embedded device to connect to an Internet service that provides support for the embedded device;
connect to the Internet service via a second network interface of the portable device;
exchange first messages with the embedded device via the alternate connection; and
exchange second messages with the Internet service based on the first messages, the first messages and the second messages facilitating an interactive support session between the embedded device and the Internet service in place of the first network interface of the embedded device.

10. The computer-readable medium of claim 9, wherein the portable device is configured to act as an Internet proxy for the embedded device.

11. The computer-readable medium of claim 9, wherein the first messages are exchanged via wireless proximity networking.

12. The computer-readable medium of claim 9, wherein the first messages are exchanged via a wired multimedia interface.

13. The computer-readable medium of claim 9, wherein the first messages are encrypted by the embedded device, and wherein the portable device forms the second messages without decrypting the first messages.

14. The computer-readable medium of claim 9, wherein the instructions further cause the portable device to establish a secondary data channel with the Internet service, the secondary data channel being active during the interactive support session and facilitating communicating status of the interactive support session to a user of the portable device.

15. The computer-readable medium of claim 14, wherein the instructions further cause the portable device to:
receive a session code generated by the Internet service, the session code permitting access to the embedded device via the Internet service;
display the session code to the user; and
facilitate user communication of the session code to the Internet service via the secondary data channel.

16. A system comprising:
an embedded device comprising:
a first processor;
a remote user interface; and
a proximity connection means coupled to the remote user interface; and
a portable device comprising a second processor coupled to a network interface, the portable device storing instructions executable by the second processor to:
exchange first messages with the remote user interface of the embedded device via the proximity connection means; and
exchange second messages with an Internet service based on the first messages, the first messages and the second messages facilitating an interactive support session between the embedded device and the Internet service.

17. The system of claim 16, wherein the portable device is configured to act as an Internet proxy for the embedded device.

18. The system of claim 16, wherein the first messages are encrypted by the embedded device, and wherein the portable device forms the second messages without decrypting the first messages.

19. The system claim 16, wherein the instructions further cause the portable device to establish a secondary data channel with the Internet service, the secondary data channel being active during the interactive support session and facilitating communicating status of the interactive support session to a user of the portable device.

20. The system of claim 19, wherein the instructions further cause the portable device to:
determine a session code generated by one of the embedded device or the portable device, the session code permitting access to the embedded device via the Internet service;
display the session code to the user; and
facilitate user communication of the session code to the Internet service via the secondary data channel.
